(19) United States
(12) Patent Application Publication
(10) Pub. No.: US 2020/0260655 A1
(43) Pub. Date: Aug. 20, 2020

(54) PLANT CONTAINERS

(71) Applicant: Christopher C. Sappenfield, (US)

(72) Inventor: Christopher C. Sappenfield, Goodyear, AZ (US)

(21) Appl. No.: 16/792,855

(22) Filed: Feb. 17, 2020

Related U.S. Application Data
(60) Provisional application No. 62/807,219, filed on Feb. 18, 2019.

(51) Int. Cl. A01G 9/02

(52) U.S. Cl. CPC A01G 9/02; A01G 2009/003

(57) ABSTRACT

Provided herein are various embodiments of plant containers that facilitate removal of plants from body structures of the containers. In some embodiments, the plant containers include selectively detachable members that are configured to at least partially detach from the body structures to partition segments of the body structures from one another. In other exemplary embodiments, the plant containers include closures are configured to reversibly open and close to partition segments of the body structures from one another.

### CROSS-REFERENCE TO RELATED APPLICATIONS

This application claims the benefit of priority from U.S. Provisional Patent Application No. 62/807,219, filed Feb. 18, 2019, which is incorporated by reference in its entirety.

### BACKGROUND

Plants intended for replanting are typically at least transiently disposed in plant containers. One problem associated with those pre-existing plant containers is that plants disposed in those containers are difficult to remove from those containers when, for example, the plants are being transplanted. Accordingly, what is desirable, then are plant containers that facilitate the removal of plants from those containers.

### SUMMARY

The present disclosure provides plant containers that permit expansion of the size of openings of those containers to facilitate removal of plants from body structures of those containers when plants are at least partially disposed in those containers. In some embodiments, the plant containers include selectable partitioning mechanisms or closures.

In one aspect, the present disclosure relates to a plant container that includes a body structure comprising at least one wall portion that extends vertically from a base portion, which wall and base portions define at least one internal cavity. The body structure comprises at least one opening that communicates with the internal cavity. The plant container also includes at least one selectable partitioning mechanism that extends at least partially between a first area of the wall portion proximal to the opening and a second area of the wall portion proximal to the base portion, which partitioning mechanism comprises at least one selectively detachable member that is configured to at least partially detach from the body structure to partition segments of the body structure from one another to thereby permit expansion of a size of the opening to facilitate removal of a plant from the body structure when the plant is at least partially disposed in the internal cavity.

In another aspect, the present disclosure relates to a plant container that includes a body structure comprising at least one wall portion that extends vertically from at least one base portion, which wall and base portions together define at least one internal cavity. The body structure comprises at least one opening that communicates with the internal cavity. The plant container also includes at least two selectively detachable members that are each configured to at least partially detach from the body structure to partition segments of the body structure from one another to thereby permit expansion of a size of the opening to facilitate removal of a plant from the body structure when the plant is at least partially disposed in the internal cavity. The selectively detachable members each extend between a first area of the wall portion proximal to the opening and a second area of the wall portion proximal to the base portion. The selectively detachable members are each fabricated sufficiently integral with the body structure to permit manual detachment of the selectively detachable members at least partially from the body structure. The selectively detachable members are also disposed substantially opposite one another. In addition, the selectively detachable members each comprise at least one ergonomic feature that facilitates the manual detachment of the selectively detachable members at least partially from the body structure. The plant container also includes at least one groove structure disposed at least partially in the base portion. The groove structure substantially aligns with, and substantially extends between, the selectively detachable members, which groove structure facilitates the expansion of the size of the opening when the selectively detachable members are at least partially detached from the body structure.

In another aspect, the present disclosure relates to a plant container that includes a body structure comprising at least one wall portion that extends vertically from at least one base portion, which wall and base portions together define at least one internal cavity. The body structure comprises at least one opening that communicates with the internal cavity. The plant container also includes at least two closures operably connected to the body structure, which closures are each configured to reversibly open and close to partition segments of the body structure from one another when the closures are open to thereby permit expansion of a size of the opening to facilitate removal of a plant from the body structure when the plant is at least partially disposed in the internal cavity. The closures each extend between first areas of the wall portion proximal to the opening and second areas of the wall portion proximal to the base portion, and wherein the closures are disposed substantially opposite one another.

In another aspect, the present disclosure relates to a plant container that includes a body structure comprising at least one wall portion that extends vertically from at least one base portion, which wall and base portions together define at least one internal cavity. The body structure also comprises at least one opening that communicates with the internal cavity. The plant container also includes at least two closures operably connected to the body structure, which closures are each configured to reversibly open and close to partition segments of the body structure from one another when the closures are open to thereby permit expansion of a size of the opening to facilitate removal of a plant from the body structure when the plant is at least partially disposed in the internal cavity. The closures each extend between first areas of the wall portion proximal to the opening and second areas of the wall portion proximal to the base portion, wherein the closures are disposed substantially opposite one another, wherein each of the closures comprises first and second opposing tracks, wherein the first track comprises a first profile and the second track comprises a second profile, wherein the first and second profiles are releasably engageable with one another, and wherein each of the closures comprises at least one slider component slidably connected to the first and/or second tracks, which slider components are configured to engage and disengage the first and second profiles in response to movement along the first and second tracks.

In some embodiments, the wall portion substantially surrounds a perimeter of the base portion. In certain embodiments, one or more of the selectively detachable members are configured to completely detach from the body structure. In some embodiments, the selectively detachable members are each fabricated sufficiently integral with the body structure via one or more at least partially and/or intermittently perforated regions that permit the manual detachment of the selectively detachable members at least partially from the body structure. In certain embodiments, one or more indentations are disposed proximal to the ergonomic feature, which indentations are structured to further facilitate the manual detachment of the selectively detachable members at least partially from the body structure. In some embodiments, a body structure includes one or more stacking elements that are structured to receive one or more portions of other plant containers (e.g., at least portions of detachable members and/or closures that protrude from the body structure) to permit multiple (e.g., 2, 3, 4, 5, 6, 7, 8, 9, 10, 15, 20, or more) plant containers to be stacked together (e.g., when the plant containers do not include plants).

In certain embodiments, the plant containers include at least four selectively detachable members that are each configured to at least partially detach from the body structure to partition segments of the body structure from one another, wherein a first pair of the selectively detachable members are disposed substantially opposite one another, and wherein a second pair of the selectively detachable members are disposed substantially opposite one another. In some embodiments, the plant containers include at least two groove structures disposed at least partially in the base portion, wherein at least a first groove structure substantially aligns with, and substantially extends between, the first pair of the selectively detachable members, and wherein at least a second groove structure substantially aligns with, and substantially extends between, the second pair of the selectively detachable members. In some embodiments, a profile of the groove structure forms approximately a 90° angle when the segments of the body structure are in a closed position.

In certain embodiments, the ergonomic feature comprises a tab structure, whereas in other exemplary embodiments, the ergonomic feature comprises a ring structure. Typically, the selectively detachable members or the closures extend substantially vertically between the first areas of the wall portion proximal to the opening and the second areas of the wall portion proximal to the base portion.

In some embodiments, the plant containers include first retaining mechanisms operably connected to the body structure, which first retaining mechanisms are configured to reversibly retain the slider components in closed positions. In some embodiments, the plant containers include second retaining mechanisms operably connected to the body structure, which second retaining mechanisms are configured to reversibly retain the slider components in open positions. In certain embodiments, the first tracks comprise spaced first notches that interrupt at least the first profile, and/or wherein the second tracks comprise spaced second notches that interrupt at least the second profile. In certain embodiments, the first tracks each comprise at least a first fin extending from the first profile, wherein the second tracks each comprise at least a second fin extending from the second profile, and wherein the first fin is detachably connected or connectable to the second fin. In certain embodiments, the plant containers include at least two groove structures disposed at least partially in the base portion, wherein at least a first groove structure substantially aligns with, and substantially extends between, the closures to a first side of the closures, and wherein at least a second groove structure substantially aligns with, and substantially extends between, the closures to a second side of the closures, which groove structures facilitate the expansion of the size of the opening when the closures are in an open position. In certain embodiments, the slider components comprise operably connected separator projections that are configured to detach the first tracks and the second tracks from one another when the slider components are moved to open positions.

### BRIEF DESCRIPTION OF THE DRAWINGS

The description provided herein is better understood when read in conjunction with the accompanying drawings which are included by way of example and not by way of limitation. It will be understood that like reference numerals identify like components throughout the drawings, unless the context indicates otherwise. It will also be understood that some or all of the figures may be schematic representations for purposes of illustration and do not necessarily depict the actual relative sizes or locations of the elements shown,

FIG. 1A schematically shows a plant container from a top view according to one exemplary embodiment.

FIG. 1B schematically shows the plant container from FIG. 1A from a side view.

FIG. 10 schematically shows selectively detachable members of a selectable partitioning mechanism partially detached from the plant container from FIG. 1A from a side view.

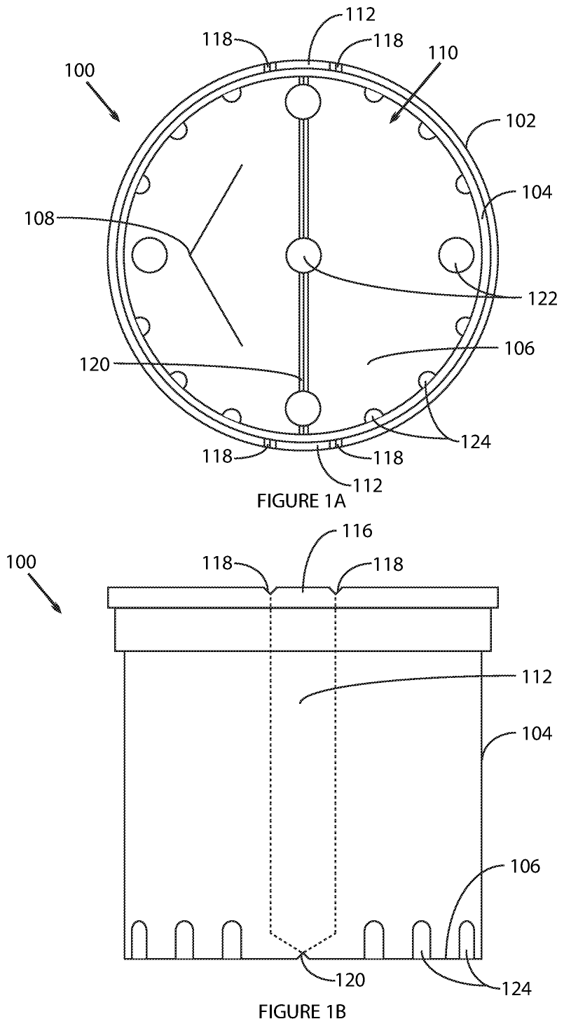

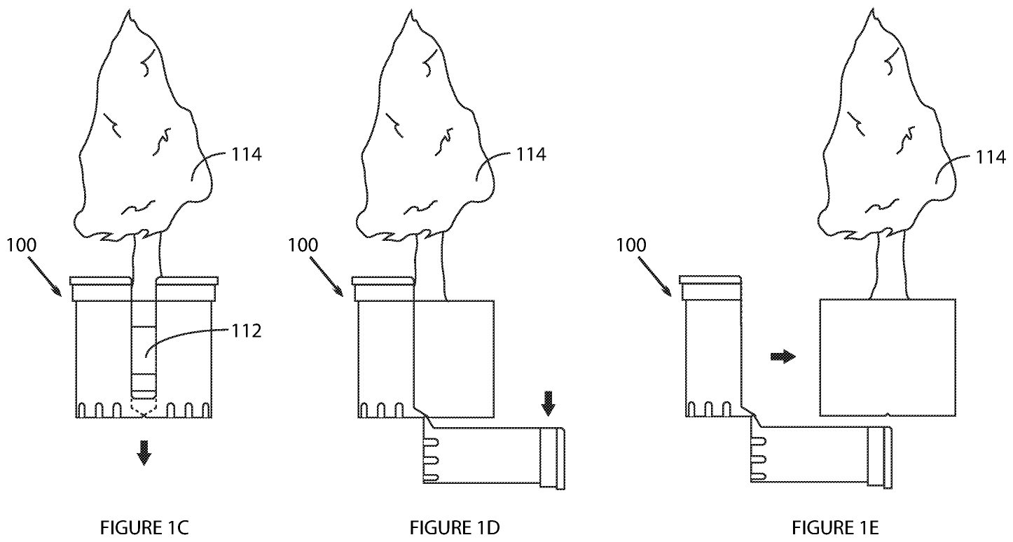

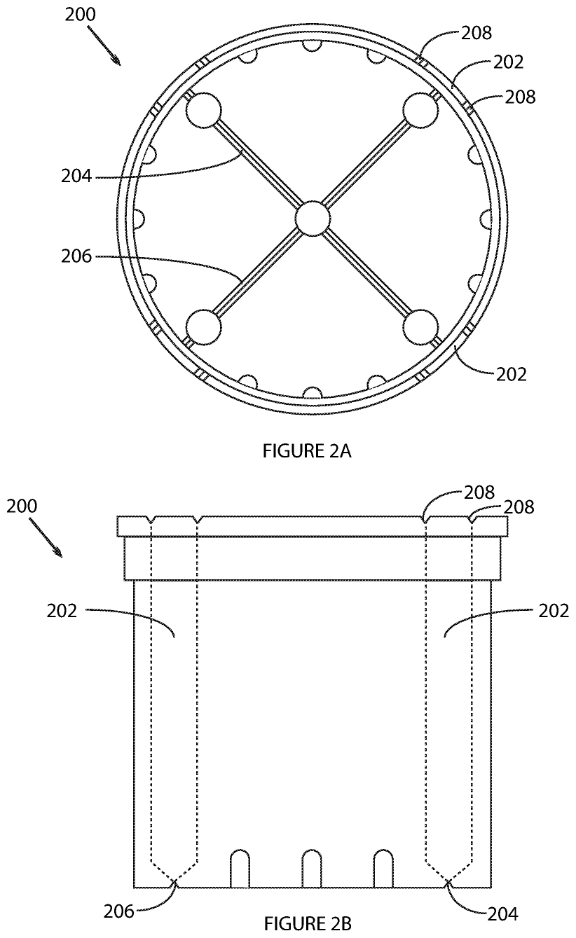

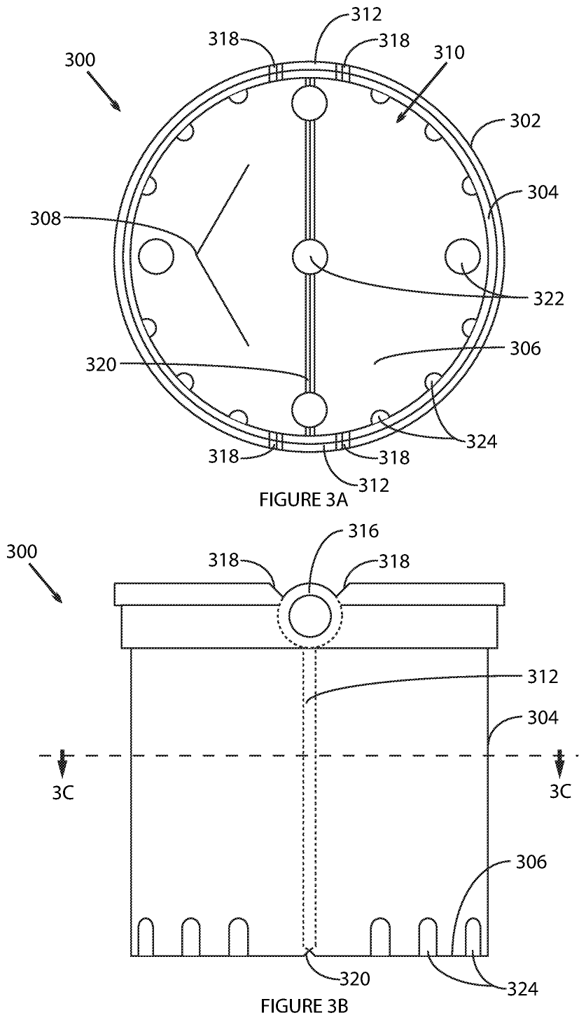

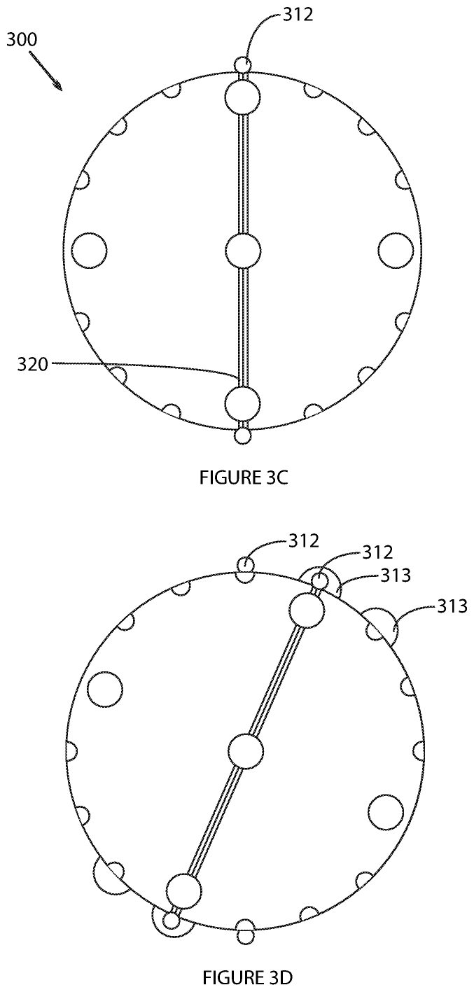

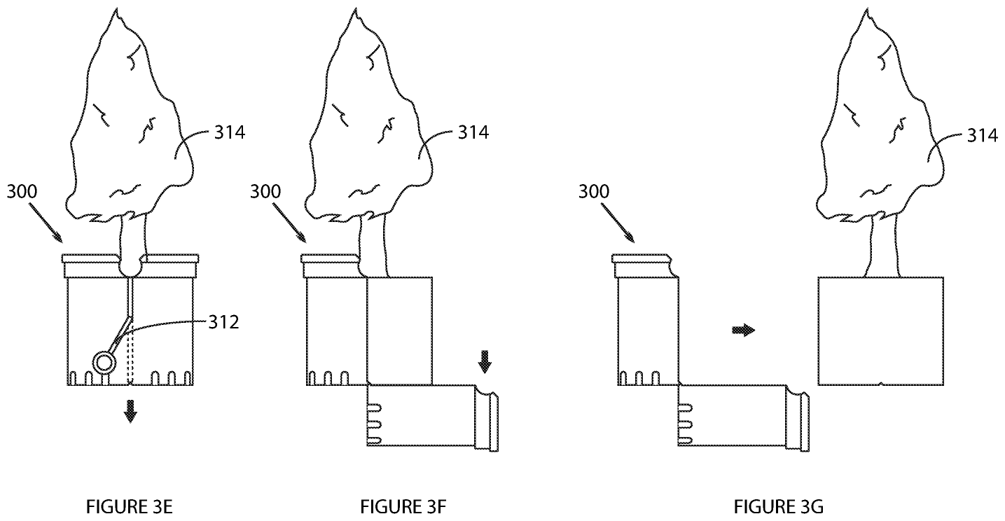

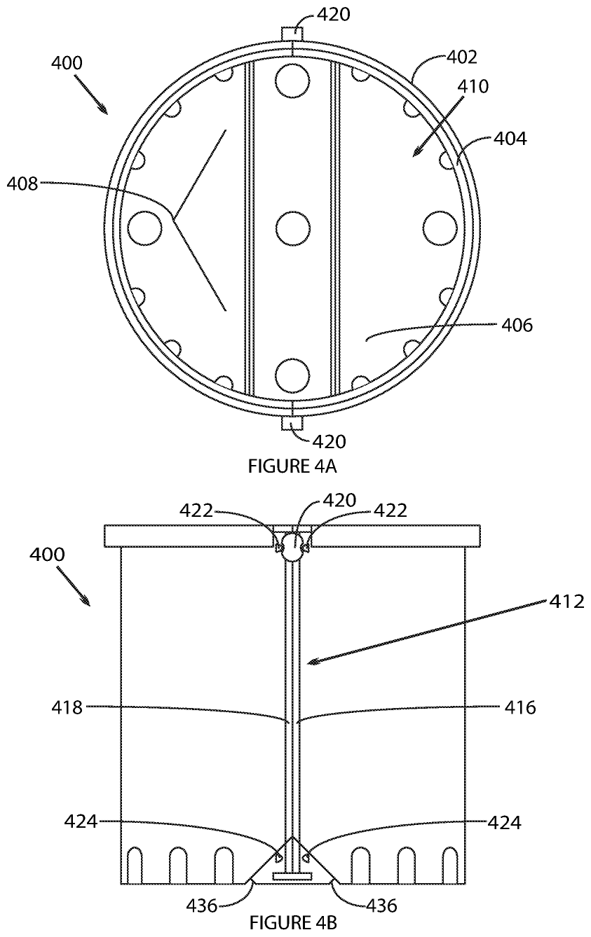

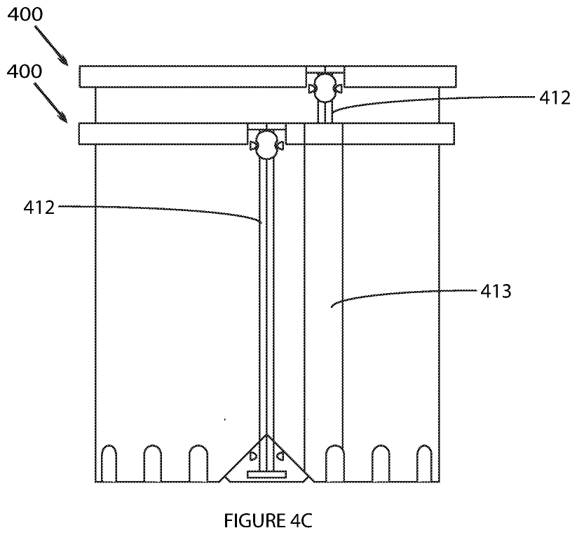

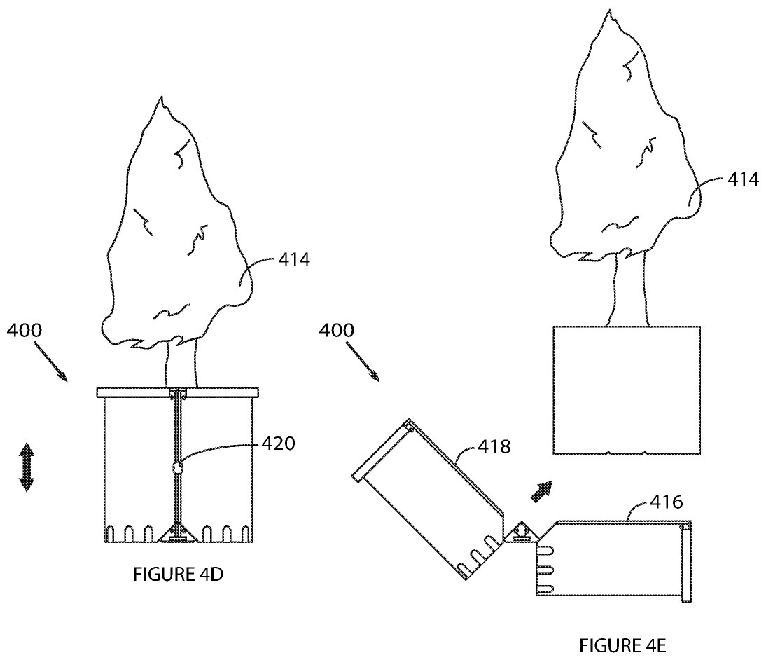

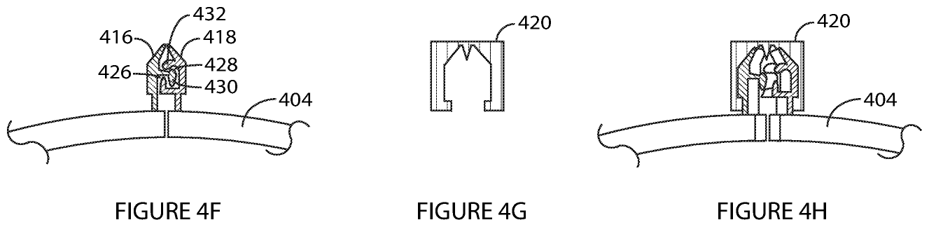

FIG. 1D schematically shows the plant container from FIG. 10 with the selectively detachable members detached from the plant container to partition segments of the body structure of the plant container from one another.

FIG. 1E schematically shows a potted plant being removed from the plant container from FIG. 1D.

FIG. 2A schematically shows a plant container from a top view according to one exemplary embodiment.

FIG. 2B schematically shows the plant container from FIG. 2A from a side view.

FIG. 3A schematically shows a plant container from a top view according to one exemplary embodiment.

FIG. 3B schematically shows the plant container from FIG. 3A from a side view.

FIG. 3C schematically shows the plant container from FIG. 3A from a top sectional view.

FIG. 3D schematically shows two plant containers stacked together using stacking elements from a top sectional view.

FIG. 3E schematically shows selectively detachable members of a selectable partitioning mechanism partially detached from the plant container from FIG. 3A from a side view.

FIG. 3F schematically shows the plant container from FIG. 3E with the selectively detachable members detached from the plant container to partition segments of the body structure of the plant container from one another,

FIG. 3G schematically shows a potted plant being removed from the plant container from FIG. 3F.

FIG. 4A schematically shows a plant container from a top view according to one exemplary embodiment.

FIG. 4B schematically shows the plant container from FIG. 4A from a side view.

FIG. 4C schematically shows two plant containers stacked together using stacking elements from a side view.

FIG. 4D schematically shows slider components of the plant container from FIG. 4A partially open from a side view.

FIG. 4E schematically shows a potted plant being removed from the plant container from FIG. 4A in which the slider components are in an open position.

FIG. 4F schematically shows first and second tracks of a closure engaged with one another from a detailed sectional view according to some exemplary embodiments.

FIG. 4G schematically shows a slider component from a sectional view according to one exemplary embodiment.

FIG. 4H schematically shows the slider component from FIG. 4G and first and second tracks from FIG. 4F positioned relative to one another from a sectional view.

### DETAILED DESCRIPTION

The present disclosure provides plant containers that are useful in numerous applications, including, for example, in facilitating the removal of plants potted or otherwise disposed in the plant containers as part of transplantation processes. In some exemplary embodiments, the plant containers are disposable (e.g., intended primarily for single use, such as one transplantation of a given potted plant from a given container). In other exemplary embodiments, the plant containers are reusable such that these containers can be used for potting and transplanting multiple plants.

To illustrate, FIGS. 1A-E schematically show a plant container from various views according to one exemplary embodiment. As shown, plant container 100 includes body structure 102, which includes wall portion 104 that extends vertically from base portion 106. Wall portion 104 and base portion 106 together define internal cavity 108. In the exemplary embodiment shown in FIGS. 1A-E, wall portion 104 substantially surrounds a perimeter of base portion 106. Plant container 100 also includes opening 110 at a top portion of body structure 102 that communicates with internal cavity 108. As shown, for example, in FIG. 1C a potted plant can be partially disposed within internal cavity 108 and extend from body structure 102 through opening 110. Plant container 100 also includes selectable partitioning mechanism 112 that extends at least partially between a first area of the wall portion 104 proximal to opening 110 and a second area of the wall portion 104 proximal to base portion 106. As shown, selectable partitioning mechanism 112 includes two selectively detachable members that are each configured to at least partially detach from body structure 102 to partition segments of body structure 102 from one another to thereby permit expansion of a size of opening 110 to facilitate removal of plant 114 from body structure 102 when plant 114 is at least partially disposed in internal cavity 108. As also shown, the two selectively detachable members of selectable partitioning mechanism 112 are disposed substantially opposite one another plant container 100.

As shown, the two selectively detachable members of selectable partitioning mechanism 112 are each fabricated sufficiently integral with body structure 102 to permit manual detachment of the selectively detachable members at least partially from body structure 102. In the exemplary embodiments shown in FIGS. 1A-E, the selectively detachable members of selectable partitioning mechanism 112 are configured to completely detach from the body structure. In some embodiments, selectively detachable members are fabricated sufficiently integral with body structures via at least partially and/or intermittently perforated regions that permit the manual detachment of the selectively detachable members at least partially from the body structures. In the exemplary embodiment shown in FIGS. 1A-E, the selectively detachable members of selectable partitioning mechanism 112 include partially and intermittently perforated regions that permit the manual detachment of the selectively detachable members from body structure 102. As also shown, the selectively detachable members of plant container 100 each comprise ergonomic feature 116 (shown as a tab structure) that facilitates the manual detachment of the selectively detachable members from body structure 102. Plant container 100 also includes indentations 118 (shown as notched areas) disposed proximal to ergonomic features 116. Indentations 118 are structured to further facilitate the manual detachment of the selectively detachable members from body structure 102.

As shown, plant container 100 also includes groove structure 120 disposed in base portion 106. Groove structure 120 substantially aligns with, and substantially extends between, the selectively detachable members of selectable partitioning mechanism 112. Groove structure 120 facilitates the expansion of the size of opening 110 when the selectively detachable members are at least partially detached from body structure 102. In the exemplary embodiment shown in FIGS. 1A-E, a profile of the groove structure forms approximately a 90° angle when the segments of body structure 102 are in a closed position (e.g., as shown in FIG. 1B). As used herein, the term “about” or “approximately” as applied to one or more values or elements of interest, refers to a value or element that is similar to a stated reference value or element. In certain embodiments, the term “about” or “approximately” refers to a range of values or elements that falls within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value or element unless otherwise stated or otherwise evident from the context (except where such number would exceed 100% of a possible value or element).

Optionally, plant container 100 includes drainage holes 122 to, for example, permit excess water or other fluids to drain from plant container 100 when plant 114 is watered, fertilized, and/or the like in plant container 100. In addition, plant container 100 also optionally includes structural support features 124 (shown structural ribs or indentations). Structural support features 124 provide additional structural support or integrity to plant container 100.

In another exemplary embodiment, FIGS. 2 A and B schematically show a plant container from top and side views, respectively. As shown, plant container 200 includes four selectively detachable members 202 that are each configured to at least partially detach from a body structure of plant container 200 to partition segments of the body structure from one another. As also shown, two pairs (first and second pairs) of the selectively detachable members 202 are disposed substantially opposite one another (e.g., approximately 180° opposite one another in a wall portion of plant container 200). Plant container 200 also includes two groove structures disposed at least partially in a base portion of plant container 200. First groove structure 204 substantially aligns with, and substantially extends between, a first pair of selectively detachable members 202, and a second groove structure 206 substantially aligns with, and substantially extends between, a second pair of selectively detachable members 202. Groove structures 204 and 206 facilitate the expansion of the size of an opening of plant container 200 when selectively detachable members 202 are at least partially detached from the body structure of plant container 200. As also shown, plant container 200 also includes indentations 208 (shown as notched areas) disposed proximal to ergonomic features of selectively detachable members 202. Indentations 208 are structured to further facilitate the manual detachment of selectively detachable members 202 from the body structure of plant container 200.

To further illustrate, FIGS. 3A-G schematically show a plant container or aspects thereof from various views according to exemplary embodiments. As shown, plant container 300 includes body structure 302, which includes wall portion 304 that extends vertically from base portion 306. Wall portion 304 and base portion 306 together define internal cavity 308. In the exemplary embodiments shown in FIGS. 3A-G, wall portion 304 substantially surrounds a perimeter of base portion 306. Plant container 300 also includes opening 310 at a top portion of body structure 302 that communicates with internal cavity 308. As shown, for example, in FIG. 3E a potted plant can be partially disposed within internal cavity 308 and extend from body structure 302 through opening 310. Plant container 300 also includes selectable partitioning mechanism 312 that extends at least partially between a first area of the wall portion 304 proximal to opening 310 and a second area of the wall portion 304 proximal to base portion 306. As shown, selectable partitioning mechanism 312 includes two selectively detachable members that are each configured to at least partially detach from body structure 302 to partition segments of body structure 302 from one another to thereby permit expansion of a size of opening 310 to facilitate removal of plant 314 from body structure 302 when plant 314 is at least partially disposed in internal cavity 308. As also shown, the two selectively detachable members of selectable partitioning mechanism 312 are disposed substantially opposite one another plant container 300.

In some exemplary embodiments, the plant containers disclosed herein include one or more stacking elements that are structured to receive one or more portions of other plant containers (e.g., at least portions of detachable members and/or closures that protrude from the body structure) to permit multiple (e.g., 2, 3, 4, 5, 6, 7, 8, 9, 10, 15, 20, or more) plant containers to be stacked together (e.g., when the plant containers do not include plants). For example, FIG. 3D schematically shows two plant containers stacked together using stacking elements 313 from a top sectional view according to an exemplary embodiment.

As shown, the two selectively detachable members of selectable partitioning mechanism 312 are each fabricated sufficiently integral with body structure 302 to permit manual detachment of the selectively detachable members at least partially from body structure 302. In the exemplary embodiments shown in FIGS. 3A-G, the selectively detachable members of selectable partitioning mechanism 312 are configured to completely detach from the body structure. In some embodiments, selectively detachable members are fabricated sufficiently integral with body structures via at least partially and/or intermittently perforated regions that permit the manual detachment of the selectively detachable members at least partially from the body structures. In the exemplary embodiment shown in FIGS. 1A-F, the selectively detachable members of selectable partitioning mechanism 312 include partially and intermittently perforated regions that permit the manual detachment of the selectively detachable members from body structure 302. As also shown, the selectively detachable members of plant container 300 each comprise ergonomic feature 316 (shown as a ring structure) that facilitates the manual detachment of the selectively detachable members from body structure 302. Plant container 300 also includes indentations 318 (shown as notched areas) disposed proximal to ergonomic features 316. Indentations 318 are structured to further facilitate the manual detachment of the selectively detachable members from body structure 302.

As shown, plant container 300 also includes groove structure 320 disposed in base portion 306. Groove structure 320 substantially aligns with, and substantially extends between, the selectively detachable members of selectable partitioning mechanism 312. Groove structure 320 facilitates the expansion of the size of opening 310 when the selectively detachable members are at least partially detached from body structure 302. In the exemplary embodiments shown in FIGS. 3A-G, a profile of the groove structure forms approximately a 90° angle when the segments of body structure 302 are in a closed position (e.g., as shown in FIG. 3B).

Optionally, plant container 300 includes drainage holes 322 to, for example, permit excess water or other fluids to drain from plant container 300 when plant 314 is watered, fertilized, and/or the like in plant container 300. In addition, plant container 300 also optionally includes structural support features 324 (shown structural ribs or indentations). Structural support features 324 provide additional structural support or integrity to plant container 300.

FIGS. 4A-H schematically show a plant container or portions thereof from various views according to exemplary embodiments. As shown, plant container 400 includes body structure 402, which includes wall portion 404 that extends vertically from base portion 406. Wall portion 404 and base portion 406 together define internal cavity 408. In the exemplary embodiments shown in FIGS. 4A-H, wall portion 404 substantially surrounds a perimeter of base portion 406. Plant container 400 also includes opening 410 at a top portion of body structure 402 that communicates with internal cavity 408. As shown, for example, in FIG. 4D a potted plant can be partially disposed within internal cavity 408 and extend from body structure 402 through opening 410. Plant container 400 includes closures 412 (one closure not within view in FIG. 4B) operably connected to body structure 402. Closures 412 are each configured to reversibly open and close to partition segments of body structure 402 from one another when closures 412 are open to thereby permit expansion of a size of opening 410 to facilitate removal of plant 414 from body structure 402 when plant 414 is at least partially disposed in internal cavity 408. As shown, closures 412 each extend between first areas of wall portion 404 proximal to opening 410 and second areas of wall portion 404 proximal to base portion 406. Closures 412 are disposed substantially opposite one another (e.g., approximately 180° opposite one another in a wall portion of plant container 400). Each closure 412 comprises first opposing track 416 and second opposing track 418. First track 416 comprises a first profile (see, e.g., FIG. 4F) and second track 418 comprises a second profile (see, e.g., FIG. 4F). The first and second profiles are releasably engageable with one another. Each closure 412 comprises slider component 420 slidably connected to the first track 416 and second track 418. Slider components 420 are configured to engage and disengage the first and second profiles in response to movement along first track 416 and second track 418. In some embodiments, first tracks 416 comprise spaced first notches 426 that interrupt at least the first profile and second tracks 418 comprise spaced second notches 428 that interrupt at least the second profile. In certain embodiments, first tracks 416 each comprise first fin 430 extending from the first profile and second tracks 418 each comprise second fin 432 extending from the second profile. First fin 430 is detachably connected or connectable to second fin 432. Slider components 420 include separator projections 434 that are configured to detach first track 416 and second track 418 when slider components 420 are moved to open positions. Additional details related to closures, tracks, slider components, and related aspects that are optionally adapted for use with the plant containers disclosed herein are described in, for example, U.S. RE44,934, US 2008/0256901, and U.S. Pat. No. 5,403,094, which are each incorporated by reference.

As also shown, plant container 400 includes first retaining mechanisms 422 operably connected to body structure 402. First retaining mechanisms 422 are configured to reversibly retain the closures in closed positions (see, e.g., FIG. 4B). Plant container 400 also includes second retaining mechanisms 424 operably connected to body structure 402. Second retaining mechanisms 424 are configured to reversibly retain the closures in open positions (see, e.g., FIG. 4E).

In some exemplary embodiments, the plant containers disclosed herein include one or more stacking elements that are structured to receive one or more portions of other plant containers (e.g., at least portions of detachable members and/or closures that protrude from the body structure) to permit multiple (e.g., 2, 3, 4, 5, 6, 7, 8, 9, 10, 15, 20, or more) plant containers to be stacked together (e.g., when the plant containers do not include plants). For example, FIG. 4C schematically shows two plant containers stacked together using stacking elements 413 from a side view according to an exemplary embodiment.

As shown, plant container 400 also includes groove structures 436 disposed in base portion 406. Each groove structure 436 substantially aligns with, and substantially extends between, one side of closures 412. Groove structures 436 facilitate the expansion of the size of opening 410 when closures 412 the closures are in an open position (see, e.g., FIG. 4E). In the exemplary embodiment shown in, for example, FIGS. 4A-E, a profile of the groove structure forms approximately a 90° angle when the segments of body structure 402 are in a closed position (e.g., as shown in FIG. 4B).

Plant container components (e.g., body structures, closures, slider components, etc.) are optionally formed by various fabrication techniques or combinations of such techniques including, e.g., cast molding, stamping, machining, embossing, extrusion, engraving, injection molding, etching (e.g., electrochemical etching, etc.), 3D printing, or other techniques. These and other suitable fabrication techniques are generally known in the art and described in, e.g., Molinari et al. (Eds.), Metal Cutting and High Speed Machining, Kluwer Academic Publishers (2002), Altintas, Manufacturing Automation: Metal Cutting Mechanics, Machine Tool Vibrations, and CNC Design, Cambridge University Press (2000), Stephenson et al., Metal Cutting Theory and Practice, Marcel Dekker (1997), Fundamentals of Injection Molding, W. J. T. Associates (2000), Whelan, Injection Molding of Thermoplastics Materials, Vol. 2, Chapman & Hall (1991), Rosato, Injection Molding Handbook, 3rd Ed., Kluwer Academic Publishers (2000), Fisher, Extrusion of Plastics, Halsted Press (1976), Chung, Extrusion of Polymers: Theory and Practice, Hanser-Gardner Publications (2000), and Redwood et al., The 3D Printing Handbook: Technologies, 1st Ed., Design and Applications, 3D Hubs (2017), which are each incorporated by reference. Exemplary materials optionally used to fabricate device components include, e.g., metal (e.g., magnetic and/or non-magnetic), glass, wood, polymethylmethacrylate, polyethylene, polydimethylsiloxane, polyetheretherketone, polytetrafluoroethylene, polystyrene, polyvinylchloride, polypropylene, polysulfone, polymethylpentene, and polycarbonate, among many others. In certain embodiments, following fabrication, device components are optionally further processed, e.g., by painting, coating surfaces with a hydrophilic coating, a hydrophobic coating, or the like.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above can be used in various combinations. All publications, patents, patent applications, and/or other documents cited in this application are incorporated by reference in their entirety for all purposes to the same extent as if each individual publication, patent, patent application, and/or other document were individually indicated to be incorporated by reference for all purposes.

What is claimed is:

1. A plant container, comprising:
a body structure comprising at least one wall portion that extends vertically from at least one base portion, which wall and base portions together define at least one internal cavity, and wherein the body structure comprises at least one opening that communicates with the internal cavity; and,
at least two closures operably connected to the body structure, which closures are each configured to reversibly open and close to partition segments of the body structure from one another when the closures are open to thereby permit expansion of a size of the opening to facilitate removal of a plant from the body structure when the plant is at least partially disposed in the internal cavity, wherein the closures each extend between first areas of the wall portion proximal to the opening and second areas of the wall portion proximal to the base portion, wherein the closures are disposed substantially opposite one another, wherein each of the closures comprises first and second opposing tracks, wherein the first track comprises a first profile and the second track comprises a second profile, wherein the first and second profiles are releasably engageable with one another, and wherein each of the closures comprises at least one slider component slidably connected to the first and/or second tracks, which slider components are configured to engage and disengage the first and second profiles in response to movement along the first and second tracks.

2. The plant container of claim 1, comprising first retaining mechanisms operably connected to the body structure, which first retaining mechanisms are configured to reversibly retain the slider components in closed positions.

3. The plant container of claim 1, comprising second retaining mechanisms operably connected to the body structure, which second retaining mechanisms are configured to reversibly retain the slider components in open positions.

4. The plant container of claim 1, wherein the first tracks comprise spaced first notches that interrupt at least the first profile, and/or wherein the second tracks comprise spaced second notches that interrupt at least the second profile.

5. The plant container of claim 1, wherein the first tracks each comprise at least a first fin extending from the first profile, wherein the second tracks each comprise at least a second fin extending from the second profile, and wherein the first fin is detachably connected or connectable to the second fin.

6. The plant container of claim 1, comprising at least two groove structures disposed at least partially in the base portion, wherein at least a first groove structure substantially aligns with, and substantially extends between, the closures to a first side of the closures, and wherein at least a second groove structure substantially aligns with, and substantially extends between, the closures to a second side of the closures, which groove structures facilitate the expansion of the size of the opening when the closures are in an open position.

7. The plant container of claim 1, wherein the closures extend substantially vertically between the first areas of the wall portion proximal to the opening and the second areas of the wall portion proximal to the base portion.

8. The plant container of any claim 1, wherein the slider components comprise operably connected separator projections that are configured to detach the first tracks and the second tracks from one another when the slider components are moved to open positions.

9. The plant container of any claim 1, wherein the body structure comprises one or more stacking elements that are structured to receive one or more portions of other plant containers to permit multiple plant containers to be stacked together.

10. A plant container, comprising:
a body structure comprising at least one wall portion that extends vertically from at least one base portion, which wall and base portions together define at least one internal cavity, and wherein the body structure comprises at least one opening that communicates with the internal cavity;
at least two selectively detachable members that are each configured to at least partially detach from the body structure to partition segments of the body structure from one another to thereby permit expansion of a size of the opening to facilitate removal of a plant from the body structure when the plant is at least partially disposed in the internal cavity, wherein the selectively detachable members each extend between a first area of the wall portion proximal to the opening and a second area of the wall portion proximal to the base portion, wherein the selectively detachable members are each fabricated sufficiently integral with the body structure to permit manual detachment of the selectively detachable members at least partially from the body structure, wherein the selectively detachable members are disposed substantially opposite one another, and wherein the selectively detachable members each comprise at least one ergonomic feature that facilitates the manual detachment of the selectively detachable members at least partially from the body structure; and,
at least one groove structure disposed at least partially in the base portion, wherein the groove structure substantially aligns with, and substantially extends between, the selectively detachable members, which groove structure facilitates the expansion of the size of the opening when the selectively detachable members are at least partially detached from the body structure.

11. The plant container of claim 10, wherein a profile of the groove structure forms approximately a 90° angle when the segments of the body structure are in a closed position.

12. The plant container of claim 10, wherein the wall portion substantially sup rounds a perimeter of the base portion.

13. The plant container of claim 10, wherein one or more of the selectively detachable members are configured to completely detach from the body structure.

14. The plant container of claim 10, wherein the selectively detachable members are each fabricated sufficiently integral with the body structure via one or more at least partially and/or intermittently perforated regions that permit the manual detachment of the selectively detachable members at least partially from the body structure.

15. The plant container of claim 10, wherein one or more indentations are disposed proximal to the ergonomic feature, which indentations are structured to further facilitate the manual detachment of the selectively detachable members at least partially from the body structure.

16. The plant container of claim 10, comprising at least four selectively detachable members that are each configured to at least partially detach from the body structure to partition segments of the body structure from one another, wherein a first pair of the selectively detachable members are disposed substantially opposite one another, and wherein a second pair of the selectively detachable members are disposed substantially opposite one another.

17. The plant container of claim 10, comprising at least two groove structures disposed at least partially in the base portion, wherein at least a first groove structure substantially aligns with, and substantially extends between, the first pair of the selectively detachable members, and wherein at least a second groove structure substantially aligns with, and substantially extends between, the second pair of the selectively detachable members.

18. The plant container of claim 10, wherein the ergonomic feature comprises a tab structure.

19. The plant container of claim 10, wherein the ergonomic feature comprises a ring structure.

20. A plant container, comprising:
a body structure comprising at least one wall portion that extends vertically from at least one base portion, which wall and base portions together define at least one internal cavity, and wherein the body structure comprises at least one opening that communicates with the internal cavity; and,
at least two closures operably connected to the body structure, which closures are each configured to reversibly open and close to partition segments of the body structure from one another when the closures are open to thereby permit expansion of a size of the opening to facilitate removal of a plant from the body structure when the plant is at least partially disposed in the internal cavity, wherein the closures each extend between first areas of the wall portion proximal to the opening and second areas of the wall portion proximal to the base portion, and wherein the closures are disposed substantially opposite one another.
